(19) United States
(12) Patent Application Publication
(10) Pub. No.: US 2026/0118043 A1
(43) Pub. Date: Apr. 30, 2026

(54) Systems and Methods for Drain Pan Pulse Heating

(71) Applicant: Rheem Manufacturing Company, Atlanta, GA (US)

(72) Inventors: Omar Alberto Fuentes Marrero, Social Circle, GA (US); Charles Graves Hall, Atlanta, GA (US)

(21) Appl. No.: 19/325,162

(22) Filed: Sep. 10, 2025

Related U.S. Application Data
(60) Provisional application No. 63/711,290, filed on Oct. 24, 2024.

(51) Int. Cl. F25D 21/14; H05B 1/02

(52) U.S. Cl. CPC F25D 21/14; H05B 1/0244; F25D 2321/1413

(57) ABSTRACT

Described herein are systems and methods for drain pan pulse heating. A drain pan of a component of a refrigeration system, such as an evaporator is provided with heating elements. The drain pan is configured to receive condensate that is produced by a heat exchanger of the component. To prevent any accumulated condensate from freezing in the drain pan, a controller activates the heating elements in the drain pan to maintain the temperature of the drain pan above a first temperature setpoint to prevent the freezing. The controller also de-activates the heating elements when the temperature of the drain pan exceeds a second temperature setpoint. The second temperature setpoint may be a temperature at which the condensate may evaporate. This is undesirable because it may result in condensate forming in the refrigerated space that the refrigeration system is cooling.

### CROSS-REFERENCE TO RELATED APPLICATIONS

This application claims priority to and benefit of U.S. provisional patent application no. 63/711,290 filed October 24, 2024, which is herein incorporated by reference.

### TECHNICAL FIELD

The present disclosure is generally in the field of refrigeration systems.

### BACKGROUND

Refrigeration systems are often used to maintain the temperature inside a refrigerated space at or below a particular setpoint temperature. For example, the refrigerated space may store perishable goods, such as food or medicine that may need to be stored in a cool space. In some refrigeration systems, a drain pan heater is provided that is used during a defrost cycle of the refrigeration system to prevent any condensate within a component of the refrigeration system from freezing. However, using the drain pan heater may result in the condensate evaporating into the refrigerated space. This may result in moisture formation within the refrigerated space, which is undesirable.

### BRIEF DESCRIPTION OF THE DRAWINGS

FIG. 1 illustrates a block diagram for an exemplary refrigeration system, in accordance with one or more embodiments of the disclosure.

FIG. 2 illustrates an evaporator of the exemplary refrigeration system of FIG. 1, in accordance with one or more embodiments of the disclosure.

FIG. 3 illustrates a heating element bracket, in accordance with one or more embodiments of the disclosure.

FIGS. 4A-4B illustrate close-up views of a drain pan, in accordance with one or more embodiments of the disclosure.

FIG. 5 illustrates a chart for drain pan pulse heating, in accordance with one or more embodiments of the disclosure.

FIG. 6 illustrates an exemplary controller, in accordance with one or more embodiments of the disclosure.

FIG. 7 illustrates a method for drain pan pulse heating, in accordance with one or more embodiments of the disclosure.

FIG. 8 illustrates a computing device, in accordance with one or more embodiments of the disclosure.

### DETAILED DESCRIPTION

The present disclosure is directed to systems and methods for drain pan pulse heating. The systems and methods described herein provide control logic for a vapor compression cycle system that is used to maintain the temperature of a drain pan within a designated range of temperatures such that the drain pan is not cold enough to cause accumulated condensate within the drain pan to freeze (thereby preventing the condensate from draining from the drain pan) and the drain pan is not warm enough to cause the accumulated condensate to evaporate into steam.

Generally, a “vapor compression system” may broadly encompass any system that is configured to heat and/or cool a conditioned space, heat and/or cool a fluid that is provided to a load, and/or perform any other actions associated with a vapor compression cycle. Non-limiting examples of types of vapor compression systems can include air conditioners (e.g., no reversing valve, only provides cooling mode), heat pumps (e.g., air source or geothermal; has a reversing valve and operates in both heating and cooling modes), heat pump water heaters, integrated heat pump water heaters, split system heat pump water heaters, heat pump water heaters with a circulation pump and a brazed plate heat exchanger, split systems, packaged systems, mini-splits, PTACs, window units, vertical packaged systems, VRF systems, etc. Reference may be made herein to “heat pumps” (or the like), however, this is not intended to be limiting and any other type of vapor compression cycle system may be applicable.

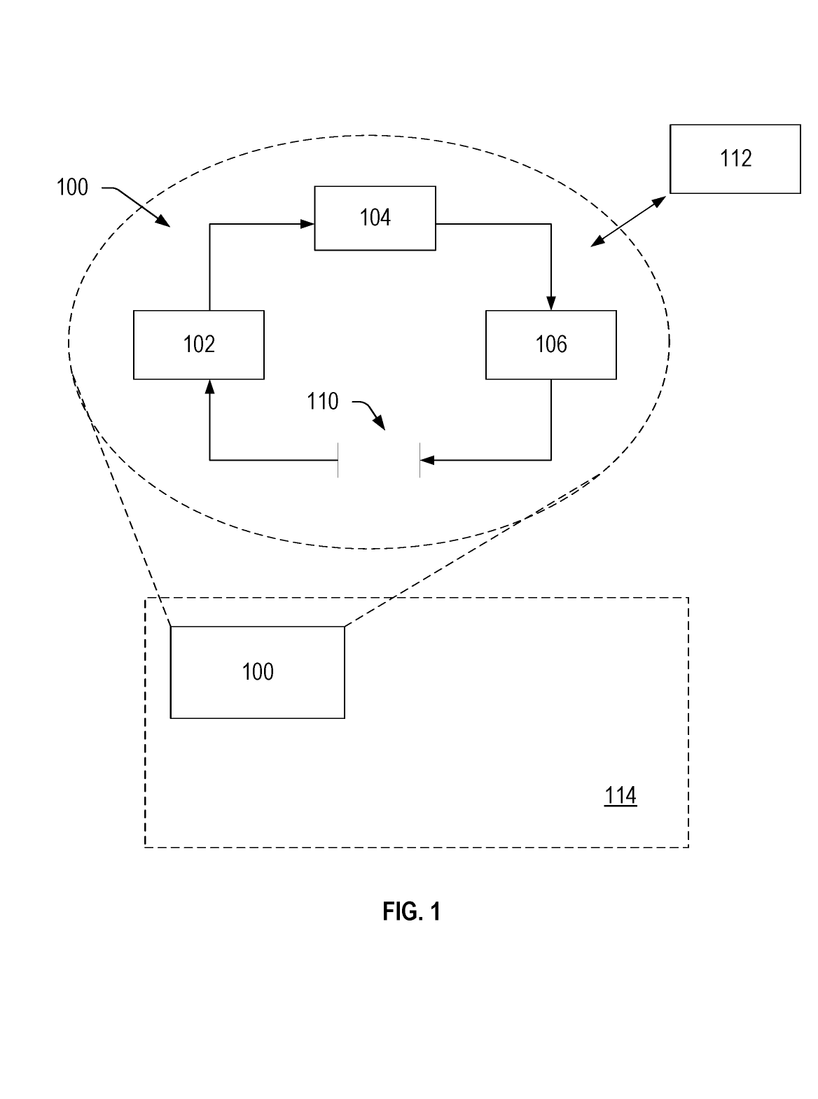

As one specific example described herein, the systems and methods described herein may be applicable in commercial refrigeration systems (high level examples of some of the components that may be included in such systems are illustrated in FIGS. 1-4B) that are used to maintain a refrigerated space at or below a defined temperature setpoint. For example, the refrigerated space may be a room or other type of enclosure that includes perishable items, such as food or medicine. However, this is not necessarily intended to be limiting and the systems and methods described herein may also be applicable in other types of commercial systems. The systems and methods may also be applicable in various types of residential systems as well. Any reference to a refrigerant system hereinafter is not necessarily intended to be limiting and other types of vapor refrigerant systems may also be applicable.

During the operation of the refrigeration system (described in further detail with respect to at least FIG. 1), a heat exchanger provided within the evaporator of the refrigeration system may produce condensate as a byproduct. To allow this condensate to drain from the evaporator (to prevent excess condensate accumulation, which may damage components of the refrigeration system or otherwise impact the refrigeration system in undesirable ways), a drain pan may be provided in the evaporator. As the condensate is produced by the heat exchanger, the condensate may fall into the drain pan (the drain pan may be located below the heat exchanger). A certain amount of condensate may accumulate within the drain pan, however, the condensate is ultimately able to drain from a drain pipe provided in the drain pan. The surface of the drain pan may also be sloped towards the drain pipe such that the condensate is naturally directed towards the drain pipe.

Given that the purpose of the refrigeration system is to maintain the temperature of the refrigerated space at a relatively low temperature (which may vary depending on the contents of the refrigerated space), the potential exists for the condensate to freeze within the drain pan (or other portions of the evaporator or any other component of the refrigeration system). This is undesirable because the frozen condensate would no longer be able to drain from the drain pan and can impact the performance of the system. Therefore, in some refrigeration systems, a heating element may be provided in the drain pan (and other locations such as on the evaporator) to maintain the drain pan at a temperature that prevents the condensate from freezing. For example, the heating element may be a resistive heating element that is in contact with the drain pan (however, other types of heating elements may also be used). However, if the heating element increases the temperature of the drain pan by too much, then the condensate may be converted into steam, which may result in moisture accumulation within the refrigerated space. Steam (and moisture) generation is undesirable in a space in which perishable items such as food and medicine are stored.

The systems and methods described herein address this potential downside of using a drain pan heating element by including control logic to maintain the temperature of the drain pan within a designated range of temperatures such that the drain pan is not cold enough to cause accumulated condensate within the drain pan to freeze (thereby preventing the condensate from draining from the drain pan) and the drain pan is not warm enough to cause the accumulated condensate to evaporate into steam. This control logic may be implemented during the defrost cycles of the refrigeration system, for example. However, the control logic may also be implemented at any other time as well. A sensor may be provided within the drain pan to monitor the current temperature of the drain pan and the heating element may either be activated or deactivated based on the data from the sensor.

In a particular embodiment, the controller may be configured to cycle one of two defrost relays to control the drain pan heater element on the evaporator. The controller may use a drain pan temperature sensor input with configured “cut-in” (e.g., activating the heating element) and “cut-out” (e.g., deactivating the heating element) temperature setpoints to maintain the drain pan at a sufficiently high warm temperature to allow proper condensation drainage but prevent the drain pan from getting too hot where steaming starts to occur.

These and other advantages of the systems and methods are described in further detail below with respect to the figures.

Turning to the figures, FIG. 1 illustrates a block diagram of an exemplary refrigeration system 100. As indicated above, the refrigeration system 100 described herein may be applicable to commercial refrigeration use cases, such as refrigeration systems used to refrigerate perishable items such as food, medication, etc. However, the same refrigeration systems and associated methods described herein are not necessarily limited to commercial refrigeration use cases and may also be applicable in other commercial or residential use cases as well. The components illustrated within FIG. 1 are not intended to be comprehensive but merely intended to illustrate some of the general components that may be included in a refrigeration system 100. One of ordinary skill in the art would appreciate that the refrigeration system 100 may be provided in other configurations as well.

In embodiments, the refrigeration system 100 may include one or more evaporators 102, one or more compressors 104, one or more condensers 106, one or more expansion valves 110, and one or more controllers 112. The refrigeration system 100 is shown as being provided in a refrigeration space 114, however, in some instances, some of the components may be located within the refrigeration space 114 and some may be located outside of the refrigeration space 114. For example, the one or more compressors 104, the one or more condensers 106, and/or the one or more expansion valves 110 may be located outside of the refrigeration space 114.

The general functionality of the refrigeration system 100 may be as follows. Refrigerant flows from the compressor 104 through the condenser 106. The condenser 106 converts the refrigerant from a vapor form to a liquid form and emits heat. The refrigerant then progresses through the expansion valve 110 and the pressure of the refrigerant is reduced. Finally, the refrigerant reaches the evaporator 102, which collects heat from the refrigeration space 114 and the refrigerant is turned into a vapor again. Finally, the refrigerant returns to the compressor 104, and the cycle repeats.

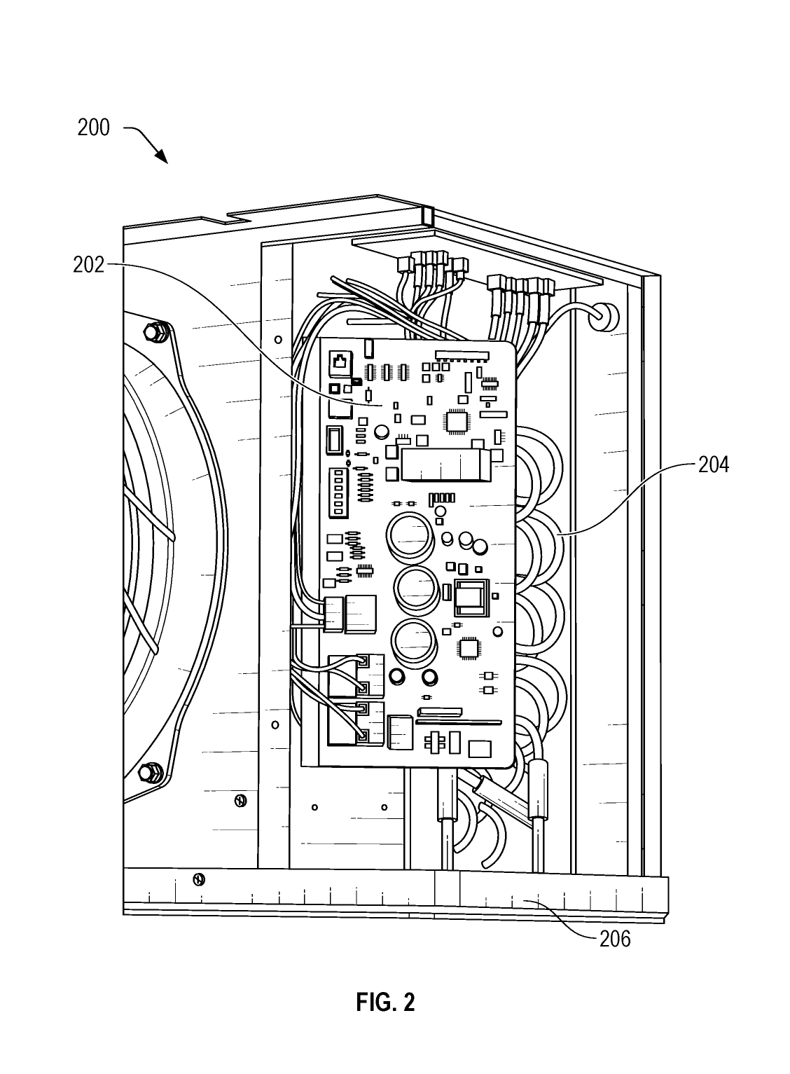

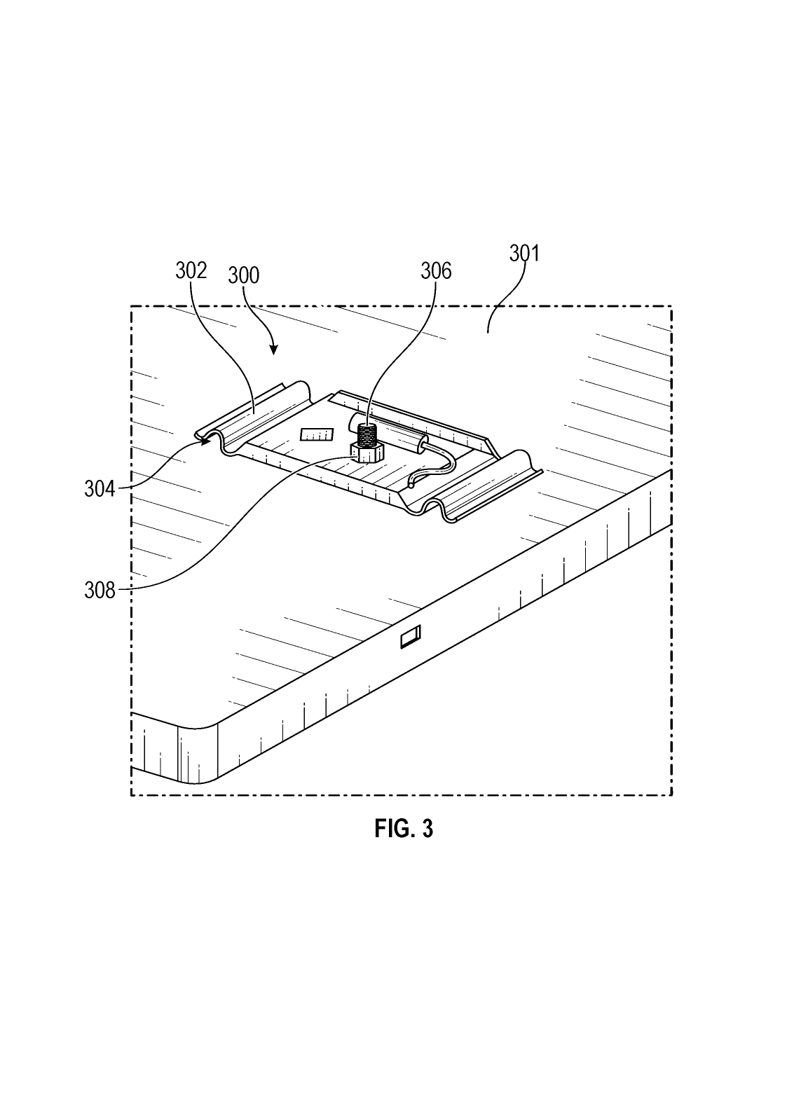

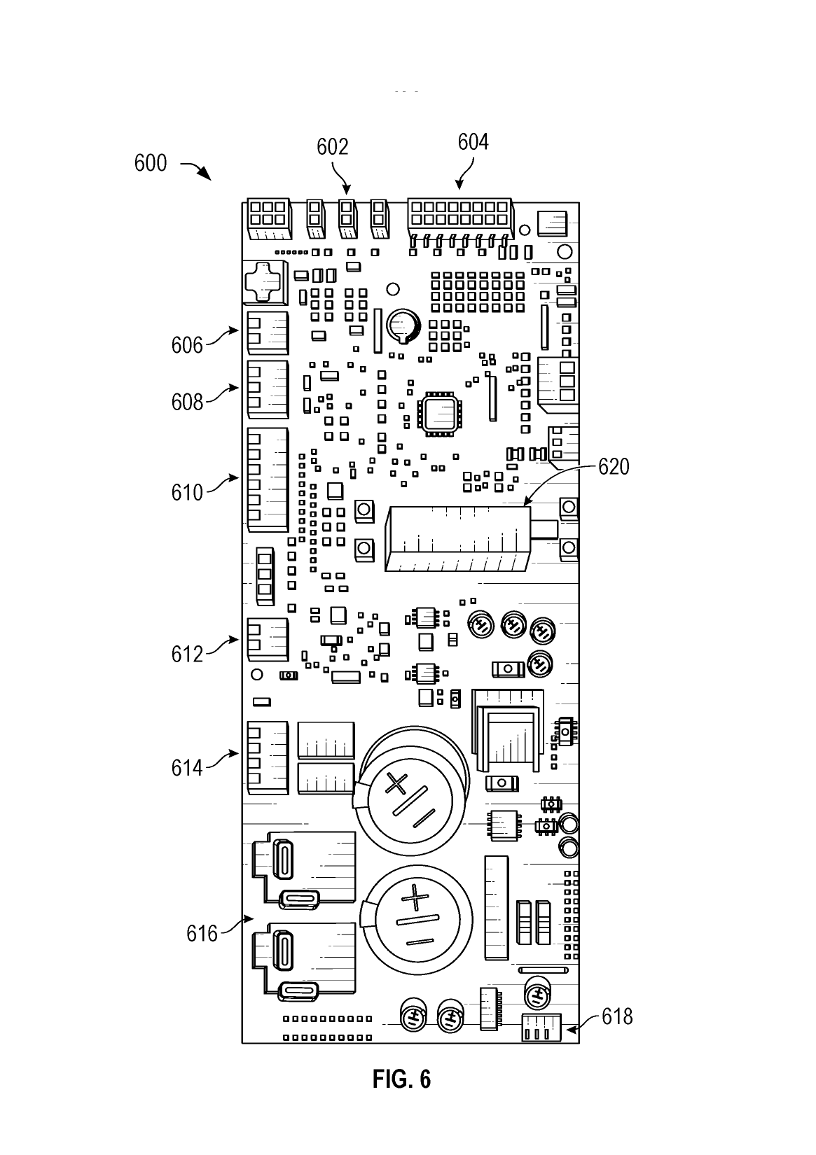

The one or more controllers 112 may be used to provide control instructions to various components of the elements of the refrigeration system 100. Examples of varying configurations of systems including controllers are shown in FIGS. 2A-3C. Additionally, FIG. 6 provides an example of a controller 6100 that may be used. In some embodiments, the one or more controllers 112 may be located at the one or more evaporators 102 (for example, within or on the one or more evaporators). In some instances, each evaporator 102 may include its own individual controller. However, other configurations may also be possible in which only one evaporator includes a controller 112 or a subset of all available evaporators 102 in the refrigeration system 100 include controllers 12.

Additionally, while reference is made to the one or more controllers 112 located on or within the one or more evaporators 102, this is not intended to be limiting and the one or more controllers 112 may also be provided at any other location or combination of different types of locations within the refrigeration system 100. As other non-limiting examples, the one or more controllers 112 may be located on and/or within the one or more compressors 104 and/or the one or more condensers 106. The controllers 112 may also be provided as standalone components within the refrigeration system 100, rather than being provided on and/or within the one or more evaporators 104, compressors 104, condensers 106, etc.

Furthermore, the one or more controllers 112 may not necessarily be local (or all be local if multiple controllers are used) to the other components of the refrigeration system 100. That is, one or more of the controllers 112 may also be located remotely from the other components of the refrigeration system 100 and may perform remote processing as well. For example, a local controller may perform communications with a remote controller and the local controller and/or the remote controller may process data received from the other components of the refrigeration system 100 and/or may provide control instructions to the other components of the refrigeration system 100 or the one or more controllers may also be located remotely from the refrigeration system 100. In instances in which all of the one or more controllers are located remotely from the refrigeration system 100, the remote controller(s) may perform the processing and transmit the control instructions to the other components of the refrigeration system 100 using any suitable wired or wireless communication protocol.

FIG. 2 illustrates an evaporator 200 of the exemplary refrigeration system 100 of FIG. 1 (that is, the evaporator 200 may be the same as, or similar to, evaporator 102 of FIG. 1). The evaporator 200 is shown as including a controller 202, a heat exchanger 204, and a drain pan 206. While FIG. 2 shows some of the general elements that may be included in an evaporator 202, one of ordinary skill in the art would appreciate that the evaporator 200 may also include any other standard elements of an evaporator. Additionally, although FIG. 2 shows an evaporator with a drain pan 206, the drain pan pulse heating approach described herein may also be applicable to any other part of a refrigeration system that may include a drain pan.

During the operation of the evaporator 200, the heat exchanger 204 absorbs heat from the surrounding environment. As a byproduct of this process, the heat exchanger 204 may produce condensate. Given that the drain pan 206 is positioned below the heat exchanger 204, the condensate produced by the heat exchanger falls into the drain pan. A drain may also be provided in the drain pan such that the condensate is able to drain from the drain pan and out of the evaporator. In some instances, the drain pan 206 may be slanted towards the drain such that the condensate is directed towards the drain as the condensate accumulates within the drain pan 206.

FIG. 3 illustrates a heating element bracket 300. In some embodiments, the heating element bracket 300 may be integrated into the drain pan 301. In other embodiments, the heating element bracket 300 may be a separate structure that is attached to the drain pan 301 (such that the heating element bracket 300 may be removable from the drain pan 301, if desired). The heating element bracket 300 is shown as being attached to the drain pan 301 using a fastener 306 (such as a bolt, for example) and a nut 308. However, the heating element bracket 300 may also be attached to the drain pan 301 in any other way.

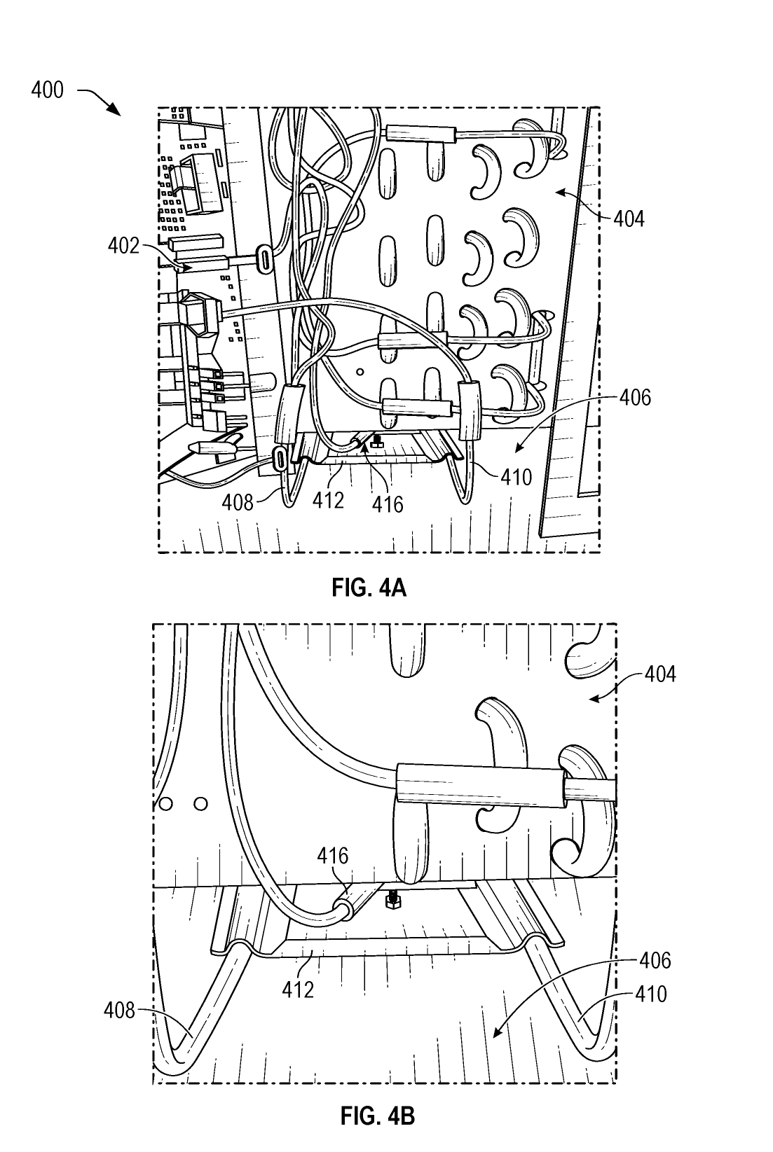

The heating element bracket 300 may include one or more curved structures 302. When the heating element bracket 300 is secured to the drain pan 301, a void 304 may exist between the drain pan 301 and the curved structures 302. The curved structure 302 and corresponding void 304 may be sized and shaped such that a heating element (not shown in FIG. 3 but shown in FIGS. 4A-4B) may be received within the void 304. Accordingly, when a heating element is inserted into the void, the curved structure 304 holds the heating element in place against the drain pan 301 (such that the heating element is then in contact with the drain pan 301). The heating element bracket 300 may include multiple of such curved structures 304 such that multiple heating elements may be provided in contact with the drain pan 301 (thereby increasing the number of contact points between the heating element(s) and the drain pan 301 to improve the heating of the drain pan 301).

The heating element bracket 300 is merely one example of a type of structure that may be used to secure a heating element against the drain pan 301 and any other structure may also be used. Additionally, in some instances, the heating element may be held into contact with the drain pan 301 without using a separate structure as well.

FIGS. 4A-4B illustrate close-up views of a drain pan 406 within a component of a refrigeration system. In this particular example, the component is an evaporator 400 (which may be the same as, or similar to, evaporator 102, evaporator 200, or any other evaporator described herein or otherwise). The evaporator is shown as including the drain pan 406, a controller 402 (which may be the same as, or similar to, controller 112, controller 600, and/or any other controller described herein or otherwise), and a heat exchanger 404. One of ordinary skill in the art will appreciate that the evaporator 400 may also include any other standard elements of an evaporator. The approach described herein may be applicable to any other type of component included in a refrigeration system that produces condensate as a byproduct of its operation and the evaporator is merely shown as an example of such a component.

FIGS. 4A-4B show that the drain pan 406 may be positioned underneath the heat exchanger 404. Accordingly, when the heat exchanger 404 produces condensate as a byproduct of its operation, the condensate may fall into the drain pan 406 and accumulate within the drain pan 406. FIGS. 4A-4B also show the heating element bracket 412 (which may be the same as, or similar to, heating element bracket 300 of FIG. 3 or any other heat element bracket described herein or otherwise) that is attached to the drain pan 406. Provided between the heating element bracket 412 and the drain pan 406 are two heating elements (for example, a first heating element 408 and a second heating element 410). While two heating elements are shown in FIGS. 4A-4B, any other number of heating elements may be provided as well. Any reference herein to a “heating element” or “heating elements” is not intended to be limiting and any number of heating element(s) may be included. In some embodiments, the heating elements may be resistive heating elements. As one of ordinary skill in the art would appreciate, a resistive heating element is a component that produces heat based on a current that is provided through the resistive heating element. Although resistive heating elements are shown in the figures, any other types of heating elements may also be used as well.

The operation of the heating elements may be controlled by the controller 402. That is, the controller 402 may selectively “activate” and “de-activate” the heating elements by controlling the current (or lack thereof) that is provided through the heating elements. Specifically, the controller 402 may cause current to be provided to the heating elements to “activate” the heating elements and the controller 402 may prevent current from being provided to the heating elements to “de-active” the heating elements. The manner by which the heating elements are activated and de-activated may vary depending on the type of heating element that is used. For example, the controller 402 may use relays to activate or de-activate a heating element. When a relay is turned on, it closes to complete the electrical circuit and allow current to flow through the heating element. When a relay is turned off, it opens to interrupt the current flow through the heater element.

The controller 402 may selectively activate and/or de-activate the heating elements based on data captured by a sensor 416. The sensor 416 may be a temperature sensor, however, other types of sensors may also be used. As is shown in the figures, the sensor 416 may be disposed in the drain pan 406 and may be in contact with a surface of the drain pan 406. Although the sensor 416 is shown as being provided at a specific location on the drain pan 406, this is merely exemplary and the sensor 416 may also be provided at any other location on the drain pan 406. Additionally, although only a single sensor is shown, any other number of sensors may also be used and the sensors may be provided at any number of different locations on the drain pan 406. Furthermore, although the sensor 416 is described herein as being provided in contact with the drain pan 406, this is not intended to be limiting and the sensor 416 may not necessarily need to be in direct contact with the drain pan 406. For example, a sensor may be provided that determines the ambient temperature within the evaporator 400 or may determine the temperature of any other element within the evaporator 400.

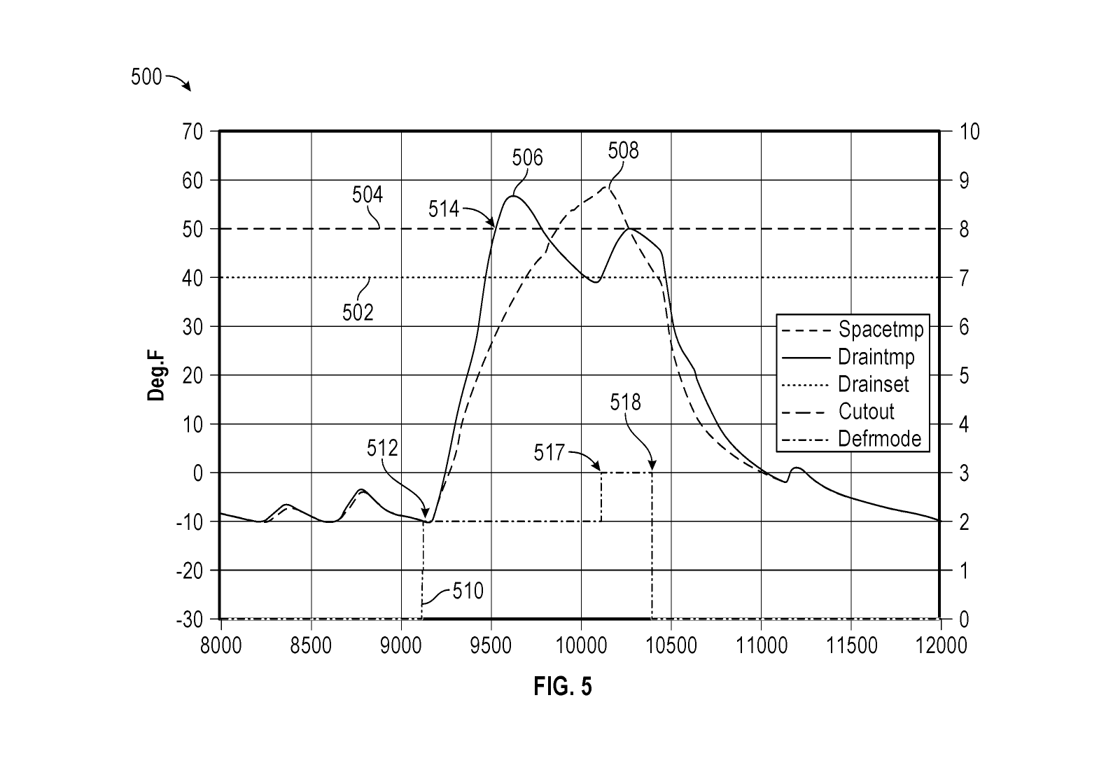

FIG. 5 illustrates a chart 500 for drain pan pulse heating. The chart 500 includes a first plot 506, a second plot 508, and a third plot 510. The first plot 506 is a plot showing the temperature of the drain pan over time. For example, the first plot 506 may be based on data that is captured by a sensor disposed in the drain pan, such as sensor 416 or any other sensor described herein or otherwise. As indicated elsewhere herein, the sensor may be a temperature sensor, however, other types of sensors may also be used. The second plot 508 shows the temperature of the space (such as the refrigerated space). The refrigeration system uses the ambient temperature of the space to determine when to turn on and/or off to maintain the space at or under the desired setpoint temperature. The third plot 510 indicates when the defrost mode of the refrigeration system is active (e.g., when the heating elements are being activated by the controller to heat the drain pan of the refrigeration system and/or any other components of the refrigeration system).

The chart 500 also shows a first temperature setpoint 502 and a second temperature setpoint 504. The first temperature setpoint 502 may be a temperature that is used as the “cut-on” point for the heating element(s) and the second temperature setpoint 502 may be the temperature that is used as the “cut-off” point for the heating element(s). In this specific example, the first temperature setpoint 502 is 40 degrees Fahrenheit and the second temperature setpoint 504 is 50 degrees Fahrenheit. Although specific temperature setpoints are shown in the chart 500, these are merely exemplary and any other setpoints may also be used. The temperature setpoint may be manually configured by a user or may be automatically determined by the refrigeration system (for example, by the controller 402). Additionally, these temperature setpoints may merely be the temperatures at the location of the sensor and the temperature of the drain pan may differ at other locations on the drain pan. Accordingly, the setpoints may be adjusted depending on the location of the sensor, or different setpoints may be used for different sensors if multiple sensors are provided to measure the drain pan temperature.

A controller (for example, controllers 112, 202, 402, 600, and/or any other controller described herein or otherwise) may compare data captured by the sensor disposed in the drain pan to determine when to activate or de-activate the heating element(s). Specifically, if the controller determines that a temperature fails to satisfy the first temperature setpoint 502, then the controller activates the heating element(s). If the controller determines that the data fails to satisfy the first temperature setpoint 504, then the controller de-activates the heating element(s).

The use of the terms “satisfies” and “fails to satisfy” with respect to a temperature setpoint as described herein may generally refer to a temperature being greater than or equal to, greater than, less than or equal to, or less than the setpoint, depending on the particular setpoint that is used as the point of comparison. Specifically, a temperature “satisfying” the first temperature setpoint 502 may indicate that the temperature is greater than or greater than or equal to the first temperature setpoint 502 (either condition may be used). A temperature “satisfying” the second temperature setpoint 504 may indicate that the temperature is less than or less than or equal to the second temperature setpoint 504 (either condition may be used). Likewise, a temperature “failing to satisfy” the first temperature setpoint 502 may indicate that the temperature is less than or less than or equal to the first temperature setpoint 502. That is, when the temperature fails to satisfy the first temperature setpoint 504, the temperature is at a point where it is possible for the condensate to freeze (either on the heat exchanger or within the drain pan, as well as any other component). A temperature “failing to satisfy” the second temperature setpoint 504 may indicate that the temperature is greater than or greater than or equal to the second temperature setpoint 504. That is, when the temperature fails to satisfy the second temperature setpoint 504, the temperature is at a point where it is possible that the condensate may evaporate from the drain pan (which may also be undesirable, as described elsewhere herein).

Specifically, FIG. 5 shows a single defrost cycle for the refrigeration system. As is shown through the third plot 510, the defrost cycle begins at the first time 512. At this time, the heating element(s) are activated by the controller to raise the temperature of the drain pan to prevent condensate from freezing in the drain pan (or to defrost any condensate that is already frozen). As indicated in the first plot 506, when the heating elements are activated at the first time 512, the temperature of the drain pan begins to rise. Once the temperature of the drain pan exceeds the second temperature setpoint 504 (which occurs at the second time 514 shown in FIG. 5), the controller de-activates the heating element(s). At this point, the temperature of the drain pan begins to fall. The temperature of the drain pan falls below the first temperature setpoint 502 and the controller again activates the heating element(s) to raise the temperature above the first temperature setpoint 502. The drain pan temperature then rises to (or above) the first temperature setpoint 504 and the controller again de-activates the heating element(s). The defrost cycle ends and the heating element(s) remain de-activated, resulting in the temperature falling below the first temperature setpoint 502 again. At this point, the refrigeration cycle resumes such that the refrigeration system may again cool the refrigerated space. This process may then be iterated any number of times as subsequent defrost cycles are performed. That is, while only a single defrost cycle is shown in the figure, the defrost cycle may repeat any number of times.

The period between the third time 517 and the fourth time 518 is the drain period for the refrigeration system. This is the period where the heating element(s) are turned off but before refrigeration starts again to allow for any melted condensation to drain. The heating element(s), even though only energized for a few moments prior to drain time, built up enough additional heat to reheat the drain pan. Accordingly, it may still take time after the heating element(s) were turned off for the heat to dissipate, especially since during this drain time there may be no refrigeration occurring.

Although FIG. 5 shows the heating element(s) being activated and de-activated a specific number of times during the defrost cycle, this is merely exemplary and a defrost cycle may also include any other number of activations/de-activations of the heating element(s) throughout the duration of the single defrost cycle. Furthermore, although operation of the heating element(s) is illustrated and described with respect to a defrost cycle, the same approach may also be used at any other time other than defrost cycle as well. That is, the approach of maintaining the temperature of the drain pan above the first temperature setpoint 502 but below the second temperature setpoint 504 may be implemented outside of the defrost mode as well.

FIG. 6 illustrates an exemplary controller 600 (which may be the same as, or similar to any of the controllers described herein, such as controllers 112, 202, 402, etc.). In the specific configuration shown in FIG. 6, the controller 600 includes sensor connectors 602, a wire harness connector terminal 604, a power supply connector 606, a communication terminal 608, digital input terminals 610, an analog fan control terminal 612, auxiliary relay outputs 614, defrost relay outputs 616, a main power terminal 618, and a controller I/O 620 (such as a display) The configuration of the controller 600 is merely exemplary and not intended to be limiting in any way.

In one exemplary embodiment, there may be there are two defrost relays, one for one or more drain pan heating elements, and one for one or more evaporator heating elements. The pulsing operation described herein may be applied to the defrost relay for the one or more drain pan heating elements.

The controller 600 may be located in any of the components of the refrigeration system (for example, the evaporator 102, the compressor 104, the condenser 106, and/or any other component that may be included in a refrigeration system. In some instances, multiple controllers may also be provided and the controllers may be in wired or wireless communication with one another. Additionally, the controller or controllers do not necessarily need to be located at the refrigeration system itself but may also be located remotely from the refrigeration system as well. The remote controller or controllers may send wired or wireless instructions to the refrigeration system to cause the refrigeration system to perform any of the actions described herein. The remote controller or controllers may also receive data from the refrigeration system, such as temperature data (or any other types of data).

Furthermore, while the refrigeration system may perform any of these functions described herein automatically without requiring manual user intervention, a user may be able to interact with the refrigeration system either locally via the controller 600 or remotely using a separate device (for example, a smartphone, laptop or desktop computer, tablet, or any other type of device). For example, an application may be provided on the device that presents a user interface to the user. The user interface may present any types of information to the user, such as data from any sensors, the current status of the heating element(s), whether the refrigeration system is in a defrost cycle, etc. The user may also be able to provide inputs to the application to manually control operation of the refrigeration system via the controller 600.

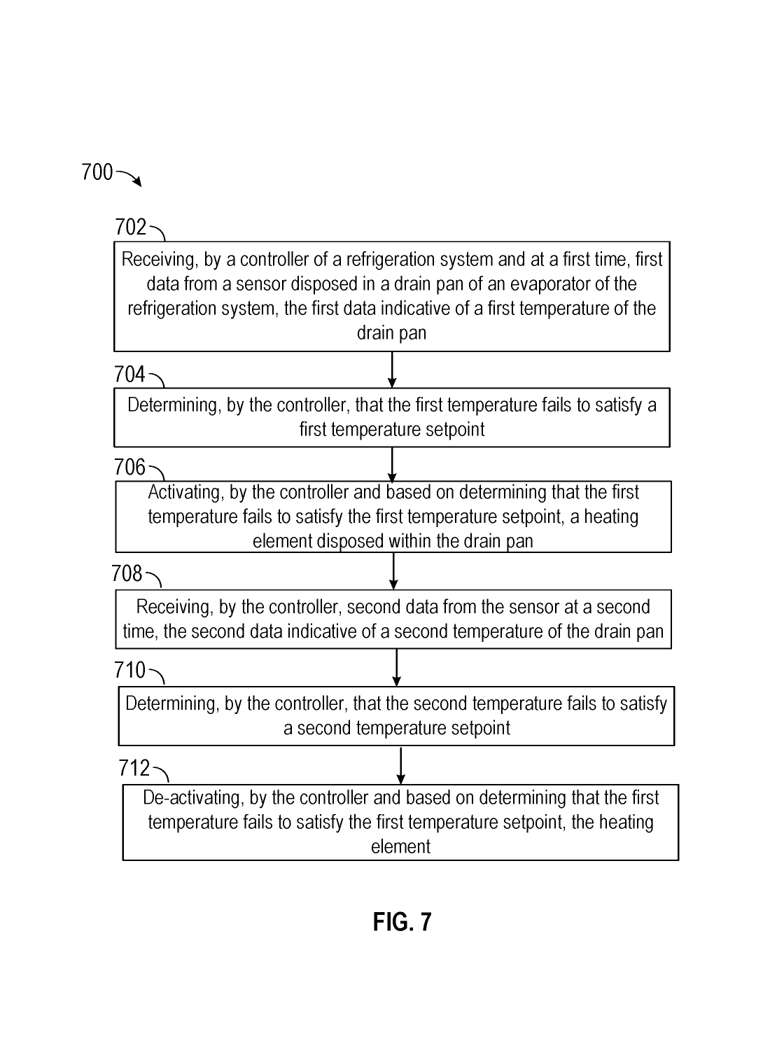

Referring now to FIG. 7, an example method 700 for drain pan pulse heating is shown. Some or all of the blocks of the process flows or methods in this disclosure may be performed in a distributed manner across any number of devices or systems (for example, any of the controllers, such as controllers 112, 202, 402, 600, etc., computing device(s) 800, etc.). The operations of the method 700 may be optional and may be performed in a different order.

At block 702 of the method 700, computer-executable instructions stored on a memory of a system or device may be executed to receive, by a controller of a refrigeration system and at a first time, first data from a sensor disposed in a drain pan of an evaporator of the refrigeration system, the first data indicative of a first temperature of the drain pan. For example, the sensor may be a temperature sensor that is in contact with the drain pan in order to obtain a temperature reading from the drain pan. However, other types of sensors positioned at other locations may also be possible.

At block 704 of the method 700, computer-executable instructions stored on a memory of a system or device may be executed to determine, by the controller, that the first temperature fails to satisfy a first temperature setpoint. As indicated above, the use of the term “satisfies” with respect to a setpoint as described herein may generally refer to a temperature being greater than or equal to, greater than, less than or equal to, or less than the setpoint, depending on the particular setpoint that is used as the point of comparison. Specifically, a temperature “satisfying” the first threshold may indicate that the temperature is greater than or greater than or equal to the first temperature setpoint (either condition may be used).

At block 706 of the method 700, computer-executable instructions stored on a memory of a system or device may be executed to activate, by the controller and based on determining that the first temperature fails to satisfy the first temperature setpoint, a heating element disposed within the drain pan (such as heating element 408, heating element 410, and/or any other heating element described herein or otherwise). For example, the hating element may be a resistive heating element. The heating element is activated in this scenario to bring the drain pan to a temperature that prevents condensate in the drain pan from freezing (or melts condensate that has already frozen.

At block 708 of the method 700, computer-executable instructions stored on a memory of a system or device may be executed to receive, by the controller, second data from the sensor at a second time, the second data indicative of a second temperature of the drain pan.

At block 710 of the method 700, computer-executable instructions stored on a memory of a system or device may be executed to determine, by the controller, that the second temperature fails to satisfy a second temperature setpoint. A temperature “satisfying” the second threshold may indicate that the temperature is less than or less than or equal to the second temperature setpoint (either condition may be used). That is, the determination that the second temperature fails to satisfy the second temperature setpoint indicates that the condensate accumulated in the drain pan has the potential to evaporate as a result of the second temperature.

At block 712 of the method 700, computer-executable instructions stored on a memory of a system or device may be executed to de-activate, by the controller and based on determining that the first temperature fails to satisfy the first temperature setpoint, the heating element. The heating element is de-activated such that the temperature of the drain pan may then reduce to a temperature at which the condensate in the drain pan is unlikely to evaporate to form steam in the refrigerated space.

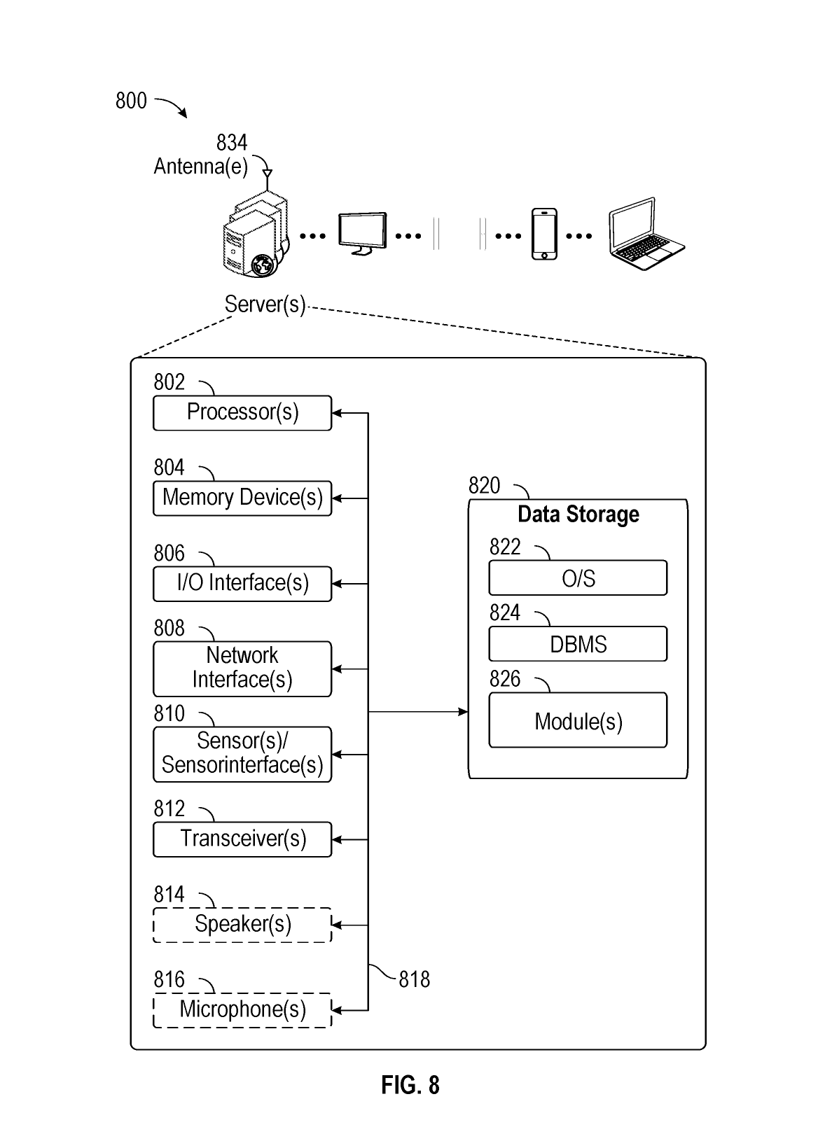

Referring now to FIG. 8, a schematic block diagram of one or more illustrative computing device(s) 800 is shown. The computing device(s) 800 may include any suitable computing device including, but not limited to, a server system, a mobile device such as a smartphone, a tablet, an e-reader, a wearable device, or the like; a desktop computer; a laptop computer; or the like. The computing device(s) 800 may correspond to an illustrative device configuration for any of the devices (e.g., any of the controllers described herein, such as controllers 112, 202, 402, 600, etc.).

The computing device(s) 800 may be configured to communicate via one or more networks. Such network(s) may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Further, such network(s) may have any suitable communication range associated therewith and may include, for example, global networks (e.g., the Internet), metropolitan area networks (MANs), wide area networks (WANs), local area networks (LANs), or personal area networks (PANs). In addition, such network(s) may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the computing device(s) 800 may include one or more processors (processor(s)) 802, one or more memory devices 804 (generically referred to herein as memory 804), one or more input/output (I/O) interfaces 806, one or more network interfaces 808, one or more sensors or sensor interfaces 810, one or more transceivers 812, one or more optional speakers 814, one or more optional microphones 816, and data storage 820. The computing device(s) 800 may further include one or more buses 818 that functionally couple various components of the computing device(s) 800. The computing device(s) 800 may further include one or more antenna(e) 834 that may include, without limitation, a cellular antenna for transmitting or receiving signals to/from a cellular network infrastructure, an antenna for transmitting or receiving WiFi signals to/from an access point (AP), a Global Navigation Satellite System (GNSS) antenna for receiving GNSS signals from a GNSS satellite, a Bluetooth antenna for transmitting or receiving Bluetooth signals, a Near Field Communication (NFC) antenna for transmitting or receiving NFC signals, and so forth. These various components will be described in more detail hereinafter.

The bus(es) 818 may include at least one of a system bus, a memory bus, an address bus, or a message bus, and may permit the exchange of information (e.g., data (including computer-executable code), signaling, etc.) between various components of the computing device(s) 800. The bus(es) 818 may include, without limitation, a memory bus or a memory controller, a peripheral bus, an accelerated graphics port, and so forth. The bus(es) 818 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnect (PCI) architecture, a PCI-Express architecture, a Personal Computer Memory Card International Association (PCMCIA) architecture, a Universal Serial Bus (USB) architecture, and so forth.

The memory 804 of the computing device(s) 800 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

In various implementations, the memory 804 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 804 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The data storage 820 may include removable storage and/or non-removable storage, including, but not limited to, magnetic storage, optical disk storage, and/or tape storage. The data storage 820 may provide non-volatile storage of computer-executable instructions and other data. The memory 804 and the data storage 820, removable and/or non-removable, are examples of computer-readable storage media (CRSM) as that term is used herein.

The data storage 820 may store computer-executable code, instructions, or the like that may be loadable into the memory 804 and executable by the processor(s) 802 to cause the processor(s) 802 to perform or initiate various operations. The data storage 820 may additionally store data that may be copied to the memory 804 for use by the processor(s) 802 during the execution of the computer-executable instructions. Moreover, output data generated as a result of execution of the computer-executable instructions by the processor(s) 802 may be stored initially in the memory 804, and may ultimately be copied to the data storage 820 for non-volatile storage.

More specifically, the data storage 820 may store one or more operating systems (O/S) 822; one or more database management systems (DBMSs) 824; and one or more program module(s), applications, engines, computer-executable code, scripts, or the like such as, for example, one or more data management module(s) 826, one or more data analysis module(s) 828, and/or one or more OBD module(s) 830. Some or all of these module(s) may be sub-module(s). Any of the components depicted as being stored in the data storage 820 may include any combination of software, firmware, and/or hardware. The software and/or firmware may include computer-executable code, instructions, or the like that may be loaded into the memory 804 for execution by one or more of the processor(s) 802. Any of the components depicted as being stored in the data storage 820 may support functionality described in reference to corresponding components named earlier in this disclosure.

The data storage 820 may further store various types of data utilized by the components of the computing device(s) 800. Any data stored in the data storage 820 may be loaded into the memory 804 for use by the processor(s) 802 in executing computer-executable code. In addition, any data depicted as being stored in the data storage 820 may potentially be stored in one or more datastore(s) and may be accessed via the DBMS 824 and loaded in the memory 804 for use by the processor(s) 802 in executing computer-executable code. The datastore(s) may include, but are not limited to, databases (e.g., relational, object-oriented, etc.), file systems, flat files, distributed datastores in which data is stored on more than one node of a computer network, peer-to-peer network datastores, or the like.

The processor(s) 802 may be configured to access the memory 804 and execute the computer-executable instructions loaded therein. For example, the processor(s) 802 may be configured to execute the computer-executable instructions of the various program module(s), applications, engines, or the like of the computing device(s) 800 to cause or facilitate various operations to be performed in accordance with one or more embodiments of the disclosure. The processor(s) 802 may include any suitable processing unit capable of accepting data as input, processing the input data in accordance with stored computer-executable instructions, and generating output data. The processor(s) 802 may include any type of suitable processing unit including, but not limited to, a central processing unit, a microprocessor, a reduced instruction set computer (RISC) microprocessor, a complex instruction set computer (CISC) microprocessor, a microcontroller, an application-specific integrated circuit (ASIC), a field-programmable gate array (FPGA), a system-on-a-chip (SoC), a digital signal processor (DSP), and so forth. Further, the processor(s) 802 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 802 may be capable of supporting any of a variety of instruction sets.

Referring now to functionality supported by the various program module(s) depicted in FIG. 8, the module(s) 826 may include computer-executable instructions, code, or the like that responsive to execution by one or more of the processor(s) 802 may perform any of the functions associated with the operation of the heating elements as described herein.

Referring now to other illustrative components depicted as being stored in the data storage 820, the O/S 822 may be loaded from the data storage 820 into the memory 804 and may provide an interface between other application software executing on the computing device(s) 800 and the hardware resources of the computing device(s) 800. More specifically, the O/S 822 may include a set of computer-executable instructions for managing hardware resources of the computing device(s) 800 and for providing common services to other application programs (e.g., managing memory allocation among various application programs). The O/S 822 may include any operating system now known or which may be developed in the future, including, but not limited to, any server operating system, any mainframe operating system, or any other proprietary or non-proprietary operating system.

The DBMS 824 may be loaded into the memory 804 and may support functionality for accessing, retrieving, storing, and/or manipulating data stored in the memory 804 and/or data stored in the data storage 820. The DBMS 824 may use any of a variety of database models (e.g., relational model, object model, etc.) and may support any of a variety of query languages. The DBMS 824 may access data represented in one or more data schemas and stored in any suitable data repository including, but not limited to, databases (e.g., relational, object-oriented, etc.), file systems, flat files, distributed datastores in which data is stored on more than one node of a computer network, peer-to-peer network datastores, or the like. In those example embodiments in which the computing device(s) 800 is a mobile device, the DBMS 824 may be any suitable lightweight DBMS optimized for performance on a mobile device.

Referring now to other illustrative components of the computing device(s) 800, the input/output (I/O) interface(s) 806 may facilitate the receipt of input information by the computing device(s) 800 from one or more I/O devices as well as the output of information from the computing device(s) 800 to one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. Any of these components may be integrated into the computing device(s) 800 or may be separate. The I/O devices may further include, for example, any number of peripheral devices such as data storage devices, printing devices, and so forth.

The I/O interface(s) 806 may also include an interface for an external peripheral device connection such as a universal serial bus (USB), FireWire, Thunderbolt, Ethernet port or other connection protocol that may connect to one or more networks. The I/O interface(s) 806 may also include a connection to one or more of the antenna(e) 834 to connect to one or more networks via a wireless local area network (WLAN) (such as WiFi) radio, Bluetooth, ZigBee, and/or a wireless network radio, such as a radio capable of communication with a wireless communication network such as a Long Term Evolution (LTE) network, WiMAX network, 3G network, etc.

The computing device(s) 800 may further include one or more network interface(s) 808 via which the computing device(s) 800 may communicate with any of a variety of other systems, platforms, networks, devices, and so forth. The network interface(s) 808 may enable communication, for example, with one or more wireless routers, one or more host servers, one or more web servers, and the like via one or more networks.

The antenna(e) 834 may include any suitable type of antenna depending, for example, on the communications protocols used to transmit or receive signals via the antenna(e) 834. Non-limiting examples of suitable antennae may include directional antennae, non-directional antennae, dipole antennae, folded dipole antennae, patch antennae, multiple-input multiple-output (MIMO) antennae, or the like. The antenna(e) 834 may be communicatively coupled to one or more transceivers 812 or radio components to which or from which signals may be transmitted or received.

As previously described, the antenna(e) 834 may include a cellular antenna configured to transmit or receive signals in accordance with established standards and protocols, such as Global System for Mobile Communications (GSM), 3G standards (e.g., Universal Mobile Telecommunications System (UMTS), Wideband Code Division Multiple Access (W-CDMA), CDMA2000, etc.), 4G standards (e.g., Long-Term Evolution (LTE), WiMax, etc.), direct satellite communications, or the like.

The antenna(e) 834 may additionally, or alternatively, include a WiFi antenna configured to transmit or receive signals in accordance with established standards and protocols, such as the IEEE 802.11 family of standards, including via 2.4 GHz channels (e.g., 802.11b, 802.11g, 802.11n), 5 GHz channels (e.g., 802.11n, 802.11ac), or 60 GHz channels (e.g., 802.11ad). In alternative example embodiments, the antenna(e) 834 may be configured to transmit or receive radio frequency signals within any suitable frequency range forming part of the unlicensed portion of the radio spectrum.

The antenna(e) 834 may additionally, or alternatively, include a GNSS antenna configured to receive GNSS signals from three or more GNSS satellites carrying time-position information to triangulate a position therefrom. Such a GNSS antenna may be configured to receive GNSS signals from any current or planned GNSS such as, for example, the Global Positioning System (GPS), the GLONASS System, the Compass Navigation System, the Galileo System, or the Indian Regional Navigational System.

The transceiver(s) 812 may include any suitable radio component(s) for—in cooperation with the antenna(e) 834—transmitting or receiving radio frequency (RF) signals in the bandwidth and/or channels corresponding to the communications protocols utilized by the computing device(s) 800 to communicate with other devices. The transceiver(s) 812 may include hardware, software, and/or firmware for modulating, transmitting, or receiving—potentially in cooperation with any of antenna(e) 834—communications signals according to any of the communications protocols discussed above including, but not limited to, one or more WiFi and/or WiFi direct protocols, as standardized by the IEEE 802.11 standards, one or more non-Wi-Fi protocols, or one or more cellular communications protocols or standards. The transceiver(s) 812 may further include hardware, firmware, or software for receiving GNSS signals. The transceiver(s) 812 may include any known receiver and baseband suitable for communicating via the communications protocols utilized by the computing device(s) 800. The transceiver(s) 812 may further include a low noise amplifier (LNA), additional signal amplifiers, an analog-to-digital (A/D) converter, one or more buffers, a digital baseband, or the like.

The sensor(s)/sensor interface(s) 810 may include or may be capable of interfacing with any suitable type of sensing device such as, for example, inertial sensors, force sensors, thermal sensors, and so forth. Example types of inertial sensors may include accelerometers (e.g., MEMS-based accelerometers), gyroscopes, and so forth.

The speaker(s) 814 may be any device configured to generate audible sound. The microphone(s) 816 may be any device configured to receive analog sound input or voice data.

It should be appreciated that the program module(s), applications, computer-executable instructions, code, or the like depicted in FIG. 6 as being stored in the data storage 820 are merely illustrative and not exhaustive and that processing described as being supported by any particular module may alternatively be distributed across multiple module(s) or performed by a different module. In addition, various program module(s), script(s), plug-in(s), application programming interface(s) (API(s)), or any other suitable computer-executable code hosted locally on the computing device(s) 800, and/or hosted on other computing device(s) accessible via one or more networks, may be provided to support functionality provided by the program module(s), applications, or computer-executable code depicted in FIG. 8 and/or additional or alternate functionality. Further, functionality may be modularized differently such that processing described as being supported collectively by the collection of program module(s) depicted in FIG. 8 may be performed by a fewer or greater number of module(s), or functionality described as being supported by any particular module may be supported, at least in part, by another module. In addition, program module(s) that support the functionality described herein may form part of one or more applications executable across any number of systems or devices in accordance with any suitable computing model such as, for example, a client-server model, a peer-to-peer model, and so forth. In addition, any of the functionality described as being supported by any of the program module(s) depicted in FIG. 8 may be implemented, at least partially, in hardware and/or firmware across any number of devices.

It should further be appreciated that the computing device(s) 800 may include alternate and/or additional hardware, software, or firmware components beyond those described or depicted without departing from the scope of the disclosure. More particularly, it should be appreciated that software, firmware, or hardware components depicted as forming part of the computing device(s) 800 are merely illustrative and that some components may not be present or additional components may be provided in various embodiments. While various illustrative program module(s) have been depicted and described as software module(s) stored in the data storage 820, it should be appreciated that functionality described as being supported by the program module(s) may be enabled by any combination of hardware, software, and/or firmware. It should further be appreciated that each of the above-mentioned module(s) may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other module(s). Further, one or more depicted module(s) may not be present in certain embodiments, while in other embodiments, additional module(s) not depicted may be present and may support at least a portion of the described functionality and/or additional functionality. Moreover, while certain module(s) may be depicted and described as sub-module(s) of another module, in certain embodiments, such module(s) may be provided as independent module(s) or as sub-module(s) of other module(s).

One or more operations of the methods, process flows, and use cases of FIGS. 1-3 may be performed by a device having the illustrative configuration depicted in FIG. 6, or more specifically, by one or more engines, program module(s), applications, or the like executable on such a device. It should be appreciated, however, that such operations may be implemented in connection with numerous other device configurations.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Program module(s), applications, or the like disclosed herein may include one or more software components, including, for example, software objects, methods, data structures, or the like. Each such software component may include computer-executable instructions that, responsive to execution, cause at least a portion of the functionality described herein (e.g., one or more operations of the illustrative methods described herein) to be performed.

A software component may be coded in any of a variety of programming languages. An illustrative programming language may be a lower-level programming language such as an assembly language associated with a particular hardware architecture and/or operating system platform. A software component including assembly language instructions may require conversion into executable machine code by an assembler prior to execution by the hardware architecture and/or platform.

Another example programming language may be a higher-level programming language that may be portable across multiple architectures. A software component including higher-level programming language instructions may require conversion to an intermediate representation by an interpreter or a compiler prior to execution.

Other examples of programming languages include, but are not limited to, a macro language, a shell or command language, a job control language, a script language, a database query or search language, or a report writing language. In one or more example embodiments, a software component including instructions in one of the foregoing examples of programming languages may be executed directly by an operating system or other software component without having to be first transformed into another form.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may include other custom-developed application software, operating system functionality (e.g., device drivers, data storage (e.g., file management) routines, other common routines, and services, etc.), or third party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program module(s), or other data transmitted within a data signal, such as a carrier wave, or other transmission. However, as used herein, CRSM does not include CRCM.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

We claim:

1. A system comprising:
a condenser;
an evaporator comprising a drain pan configured to receive condensate produced by the evaporator;
a sensor disposed within the drain pan;
a heating element disposed within the drain pan; and
a controller configured to:
receive first data from the sensor at a first time, the first data indicative of a first temperature of the drain pan;
determine that the first temperature fails to satisfy a first temperature setpoint;
activate, based on determining that the first temperature fails to satisfy the first temperature setpoint, the heating element;
receive second data from the sensor at a second time, the second data indicative of a second temperature of the drain pan;
determine that the second temperature fails to satisfy a second temperature setpoint; and
de-activating, based on determining that the second temperature fails to satisfy the second temperature setpoint, the heating element.

2. The system of claim 1, wherein determining that the first temperature fails to satisfy the first temperature setpoint further comprises determining that the first temperature is less the first temperature setpoint.

3. The system of claim 1, wherein determining that the second temperature fails to satisfy the second temperature setpoint further comprises determining that the second temperature is greater than the second temperature setpoint.

4. The system of claim 1, wherein the heating element is a resistive heating element that is in contact with the drain pan.

5. The system of claim 1, wherein the sensor is a temperature sensor that is in contact with the drain pan.

6. The system of claim 1, further comprising a bracket attached to the drain pan and configured to receive the heating element.

7. The system of claim 1, wherein the system is a commercial refrigeration system configured to maintain a temperature of a refrigerated space at or below a temperature setpoint.

8. A method comprising:
receiving, by a controller of a refrigeration system and at a first time, first data from a sensor disposed in a drain pan of an evaporator of the refrigeration system, the first data indicative of a first temperature of the drain pan;
determining, by the controller, that the first temperature fails to satisfy a first temperature setpoint;
activating, by the controller and based on determining that the first temperature fails to satisfy the first temperature setpoint, a heating element disposed within the drain pan;
receiving, by the controller, second data from the sensor at a second time, the second data indicative of a second temperature of the drain pan;
determining, by the controller, that the second temperature fails to satisfy a second temperature setpoint; and
de-activating, by the controller and based on determining that the second temperature fails to satisfy the second temperature setpoint, the heating element.

9. The method of claim 8, wherein determining that the first temperature fails to satisfy the first temperature setpoint further comprises determining that the first temperature is less the first temperature setpoint.

10. The method of claim 8, wherein determining that the second temperature fails to satisfy the second temperature setpoint further comprises determining that the second temperature is greater than the second temperature setpoint.

11. The method of claim 8, wherein the heating element is a resistive heating element that is in contact with the drain pan.

12. The method of claim 8, wherein the sensor is a temperature sensor that is in contact with the drain pan.

13. The method of claim 8, further comprising a bracket attached to the drain pan and configured to receive the heating element.

14. The method of claim 8, wherein the refrigeration system is a commercial refrigeration system configured to maintain a temperature of a refrigerated space at or below a temperature setpoint.

15. A non-transitory computer-readable medium storing computer-executable instructions which, when executed by a processor, cause the processor to perform operations comprising:
receiving, at a first time, first data from a sensor disposed in a drain pan of an evaporator of a refrigeration system, the first data indicative of a first temperature of the drain pan;
determining that the first temperature fails to satisfy a first temperature setpoint;
activating, based on determining that the first temperature fails to satisfy the first temperature setpoint, a heating element disposed within the drain pan;
receiving second data from the sensor at a second time, the second data indicative of a second temperature of the drain pan;
determining that the second temperature fails to satisfy a second temperature setpoint; and
de-activating, based on determining that the second temperature fails to satisfy the second temperature setpoint, the heating element.

16. The non-transitory computer-readable medium of claim 15, wherein determining that the first temperature fails to satisfy the first temperature setpoint further comprises determining that the first temperature is less the first temperature setpoint.

17. The non-transitory computer-readable medium of claim 15, wherein determining that the second temperature fails to satisfy the second temperature setpoint further comprises determining that the second temperature is greater than the second temperature setpoint.

18. The non-transitory computer-readable medium of claim 15, wherein the heating element is a resistive heating element that is in contact with the drain pan.

19. The non-transitory computer-readable medium of claim 15, wherein the sensor is a temperature sensor that is in contact with the drain pan.

20. The non-transitory computer-readable medium of claim 15, further comprising a bracket attached to the drain pan and configured to receive the heating element.
